(19) United States
(12) Patent Application Publication
(10) Pub. No.: US 2015/0193678 A1
(43) Pub. Date: Jul. 9, 2015

(54) Mobile Magnetic Transactions

(71) Applicant: Rahav Dor, Chesterfield, MO (US)

(72) Inventor: Rahav Dor, Chesterfield, MO (US)

(21) Appl. No.: 14/584,048

(22) Filed: Dec. 29, 2014

Related U.S. Application Data
(60) Provisional application No. 61/923,301, filed on Jan. 3, 2014.

(51) Int. Cl. G06K 19/06

(52) U.S. Cl. CPC G06K 19/06206

(57) ABSTRACT

A useful process that transfer data from a mobile device such as a smartphone directly to a magnetic card reader by mutual induction or RF (Radio Frequency). The data comprised of information that was originally stored on a card (payment card or other) in its magnetic stripe, as well as other data relevant to the transaction. Software timely generates the desired signals and the wave sequence is electromagnetically induced directly into a legacy magnetic card reader or one of its subsequent units. An optional apparatus hereby named the Magnetic Bar in one of its many physical embodiments is connected to the smartphone, or is an integral component of the smartphone, and generates the electromagnetic phenomenon.

### CROSS-REFERENCE TO RELATED APPLICATIONS

This application claims the benefits of U.S. provisional application No. 61/923,301.

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISC APPENDIX

Not Applicable.

### BACKGROUND OF THE INVENTION

1. Field of the Invention

This invention relates to electronic payments and other kind of transactions that is traditionally enabled by magnetic cards.

This invention enables mobile devices, or in particular smartphones, to transfer data by magnetic induction. The data transferred can be any kind of data, but this disclosure take a particular interest when the data is the content of the magnetic stripe of a legacy magnetic card (used for financial or none-financial transactions).

Payment cards such as credit, debit, gift, or prepaid cards are commonly used as payment methods. Similarly shaped and sized cards are used for numerous other purposes such as membership verification, loyalty, access control, or time tracking. These cards and their magnetic stripe have their dimensions, magnetic stripe location, and other properties defined in ISO/ANSI standards 7810, 7811, and 7813. These cards employ magnetic stripe (area) deposited on the surface of the card or embedded within it. In use, the card is swiped, or fed, to an apparatus that is generally called a magnetic card reader. The reader reads the data and optionally makes it available to subsequent processing unit.

For a number of years now, efforts to replace the function of the magnetic stripe as a memory device has been put forward; in particular for uses such as electronic money, ticketing, or loyalty management. Technologies¹ such as RFID, NFC, QR code and in general Barcodes, microSD, SMS, and Cloud payments has been proposed or partially implemented. In reality though, many of those efforts are in their infancy or have not been successful yet. There are many reasons for this slow adaptation. In my opinion the key reasons are the prodigious infrastructure supporting magnetic cards, consumer security and privacy concerns, and familiarity factor. ¹ RFID is an abbreviation for Radio Frequency Identification, NFC is Near Field Communication, QR is Quick Response, SD is Secure Digital, and SMS is Short Message Service.

Even including a NFC chip in some smartphone handsets did not eliminate the legacy (physical) card. Many consumers are did not feel safe and merchants did not have the infrastructure to support it; either because of the business environment or the lack of desire to invest in additional equipment at this time. Moreover, justifiably or not, NFC presents a host of new privacy and security concerns. As a result the magnetic-based card infrastructure is going to continue and be useful for many years to come; and I believe that there is room for innovation by leveraging the widespread infrastructure of magnetic card readers and the business processes supporting it, while allowing transactions to occur using modern mobile computing devices such as the smartphone.

The present invention addresses exactly this gap. It offers the benefits of using modern mobile devices while taking advantage of the existing magnetic cards infrastructure, all while adding new security measures as described in the patent application and ease of use for the cardholder.

2. Prior Art

U.S. Pat. Nos. 7,246,752 B2 and 7,044,394 B2 by Kerry Dennis Brown; and U.S. Pat. Nos. 6,308,890 B1 and 8,490,875 B2 by J. Carl Cooper; and patent application 20130228616 by Bhosle Amit—all require the use of a regular sized card and a magnetic stripe that is lengthwise deposited on or in the card. This is different from the current art as described in this patent application. The current art does not require a regular sized card, nor does it use a magnetic stripe. Furthermore, the prior arts use multiple magnetic writers to magnetize the magnetic stripe along the card length. After the magnetic stripe is magnetized with the desired data sequence the card is swiped in the legacy magnetic card reader. The current art described in this patent application does not use multiple magnetic writers or a magnetic stripe.

The Coin (www.onlycoin.com) is an electronic card capable of magnetizing its magnetic stripe with up to eight legacy cards (one at a time). Similar to above referenced patents and patent application the Coin first magnetizes its magnetic stripe and the card is swiped as a legacy card in a magnetic card reader. The current art described in this patent application does not use an electronic card which is then magnetized and swiped, in fact it avoids having a physical manifestation of the card completely and renders it unneeded under the new process described in this patent application.

Smartphones have been used before as electronic wallets. Starbucks® QR code and Google Wallet™ http://www.google.com/wallet/ are two good representative cases. In these two cases, as well as in all other prior art that we could find, smartphones have not been used or even propose to be used as magnetic cards. The current art described in this patent application, to the best of our knowledge is the first to suggest using the smartphone as magnetically inducing the data. To be precise: all prior art use of a smartphone as an electronic wallet allow cardholders to store loyalty cards and credit cards in their electronic wallet, but uses NFC or QR codes for communicating the transaction—none of them use magnetic induction.

After an extensive prior art search I believe that my (this) invention, the current art, is the first to propose to directly induce the data into the magnetic card reader. This invention:
Does not require a regular sized card
Does not utilize a magnetic stripe deposited on or embedded within the card (in fact, the card is eliminated by this invention)
Does not dynamically magnetize a magnetic stripe (in fact, there is no need for a stripe)
Is the first to articulate transferring the data by magnetic induction
   Some prior art require the use of a card that is shaped as a legacy card, other embed a magnetic stripe in a physical form factor, the rest of the prior arts use a novel form of communication (e.g. NFC, QR). None of the prior art that uses over the air communication use magnetic induction. Contrary to that, in my invention each data-“bit” is ephemeral and is directly transferred to the magnetic reader by mutual induction. Moreover, smartphones, despite being proposed as electronic wallets carrying numerous kinds of currencies or other data such as loyalty cards; thus far (until this invention) require a corresponding reader to enable their version of the electronic wallet. For example, a QR scanner is needed to read a QR code generated by the smartphone and an NFC reader is needed to read the NFC chip of the smartphone. To the best of my knowledge this invention is the first that makes use of the standard magnetic card reader and therefore does not require a corresponding new terminal to enable its utility.

Beyond these technical differences this invention eradicates a fraud technique called card skimming that plagues permanently magnetized magnetic stripes; be that those cards that are permanently magnetized or those that are dynamically magnetized. Card skimming is a fraud technique in which the content of a magnetic stripe is copied into a new card. Since my invention eliminates the stripe altogether, there is nothing that can be copied. This is a major benefit over both legacy cards as well as the dynamically magnetized cards.

I believe that currently, the best way to realize this invention is by using a smartphone. However, one skilled in the art can see that there are other realizations of this invention. For example, one of the limitations of existing RFID based or NFC based key-fobs, is that they require a corresponding RFID or NFC terminals to power or read the key-fob. In my opinion, this is one of the reasons that these technologies (such as the Exxon Mobile Speedpass) are not in common use despite the number of years that they have been promoted. Contrary to the limitation of such prior arts, an embodiment of the present invention in a key-fob form factor and have that key-fob communicates directly with an existing magnetic card reader using the technology outlined in this invention—is clearly an improvement and useful because it uses the existing magnetic card infrastructure. Similarly, one skilled in the art can see that this invention extends to other kinds of novel handheld devices and gadgets.

The present invention is different from existing RFID, NFC, QR codes, regular barcodes, microSD, SMS, Cloud payment, stickers, and Key-Fobs in that it communicates directly with the existing card reader or its subsequent units. In particular this invention does not require an additional corresponding terminal or antenna. To the best of my knowledge no technology prior to this invention had proposed to use smartphones to communicate directly with a magnetic card reader. Indeed one of the useful processes established by this invention is the use of the prodigious presence of legacy magnetic card readers and abundant investment in existing infrastructure, processes, and technology.

### BRIEF SUMMARY OF THE INVENTION

Plastic card is an inclusive common name given to varying number of payment cards and other types of cards (not necessarily payment related). Typically a payment card is a credit, debit, prepaid, ATM, gift, POS card, or others. And a “not necessarily payment” card would be membership verification, access control, time tracking, driving license, identification, and many other types of cards. What is common and of interest to this invention are those cards that contain data in one or more magnetic stripes or other magnetic area, be that area on, or embedded within the card. Before this invention these legacy card would be swiped in a magnetic card reader or fed to an appropriate reader that would read the data. The reader then could make the data available to subsequent processing or operational units.

Electronic embodiments of the legacy plastic card, as mentioned in the prior art discussion, magnetize a special magnetic stripe before it is swiped in the reader. While the electronic version of the card can change the content of its magnetic stripe, a card is still needed and a magnetic area is still magnetized.

This invention novelty stems from the process and optional apparatus, in which the data is electromagnetically induced over the air, directly into the magnetic card reading apparatus or into one of its subsequent processing or operational units. No card is used in the process and no magnetic stripe is lengthwise magnetized.

This invention is different from other over-the-air technology in that each other technology (e.g. RFID, NFC) requires the use of a corresponding terminal; they do not directly induces the data into the magnetic card reader or its subsequent units. This invention is different from other smartphone based electronic wallets in that no prior art wallet could communicate with a magnetic card reader before. In essence this invention enables a new currency on the smartphone based electronic wallet.

In one embodiment of this invention the cardholder would do an initial setup of each card to be used by the method of this invention. For example, they would perform the following steps using their smartphone:
Swipe an original card using a simple magnetic card reader connected to the smartphone
   Alternatively they could simply type the data from the front and back of the original card
Take a picture of the card face(s) or the app could offer them to use an existing generic picture that correspond to the type of card they are configuring
Autograph their signature on the smartphone
Assign the card an identifying name, nickname, and any other desired metadata
   This initial setup is needed only once for each card the cardholder wishes to enable under this invention. After the initial setup (in regular daily use) the smartphone would present the list or pictures of available cards in an easy to use user interface, the user will select which card they wish to use, and hover the smartphone over the legacy magnetic card reader. The appropriate data will be transferred to the reader by mutual induction.

There are many benefits of this invention that above example highlights. One of the greatest benefits to the cardholder is that they do not need to carry around a multitude of cards. A single mobile device such as a smartphone will suffice, but also a dedicated device or a small gadget, as one skilled in the art can see, stems from this invention.

Instead of looking for and thumbing through his or her legacy cards all of the cardholder's cards are available in a single common place, the mobile device. A smartphone App can display a nice image of the original card (for example the picture of the card that was taken during setup), as well as make available a full text search on the available cards name, nickname, card type, or any other metadata. The app will respond immediately by zooming on the matching card(s).

After selecting the desired card the user simply holds the mobile device or hovers it over the legacy card reader, and the mobile device transfers the data that was encoded in the original card magnetic apparatus, possibly with additional data if desired, to the reader over the air. This presents another benefit of this invention. There is no physical-card wear and tear, no degradation of magnetic stripe properties, no washed-out autographs, etc.

### BRIEF DESCRIPTION OF THE SEVERAL VIEWS OF THE DRAWING

FIG. 1 shows the novel Magnetic bar. The Magnetic bar is an apparatus that allows a mobile device to conducts magnetic data to a legacy magnetic card reader by mutual induction.

FIG. 1B shows the apparatus of this invention embedded within a regular audio connector.

FIG. 1C shows the apparatus of this invention as a thin sticker that uses a concentric coil as the inductive component.

### DETAILED DESCRIPTION OF THE INVENTION

As in the other sections of this discourse, in the following detailed description I will provide an example from time to time. By doing so my intention is to make the discourse clearer by way of example and not by way of limiting what this invention makes available. This description will clearly enable one skilled in the art to make and use the invention, and describes several embodiments, adaptations, variations, alternatives and uses of the invention, including what I presently believe is the best mode of carrying out the invention. As various changes could be made in the constructions described herein without departing from the scope of the invention, it is intended that all matter contained in the description or shown in the accompanying drawings shall be interpreted as illustrative and not in a limiting sense.

Card users typically have a number of such legacy payment and not-necessarily-payment cards. The users need to carry with them all of the desired cards and select the appropriate one, depending on the desired operation. Despite the fact that these cards are lightweight they are an inconvenience because they do occupy a significant volume in most people purses or wallets, simply because cardholders (users) have many of them. They are also an inconvenience by the mere fact that the user need to look through their cards to find the proper one and more often than not, they need to look in more than one place in their pocketbook or handbag.

In accordance with the invention a cardholder creates a proxy of the cards they wish to enable using this invention on a mobile device. The proxy-electronic-card may be created in a number of ways. One way was described in BRIEF SUMMARY OF THE INVENTION. Another may be a web service offered by an interested party where the data will become accessible to the smartphone via the Internet. The cards data can be pulled from the Internet or pushed to the smartphone via the Internet, or be downloaded as complete objects pluggable to the smartphone App.

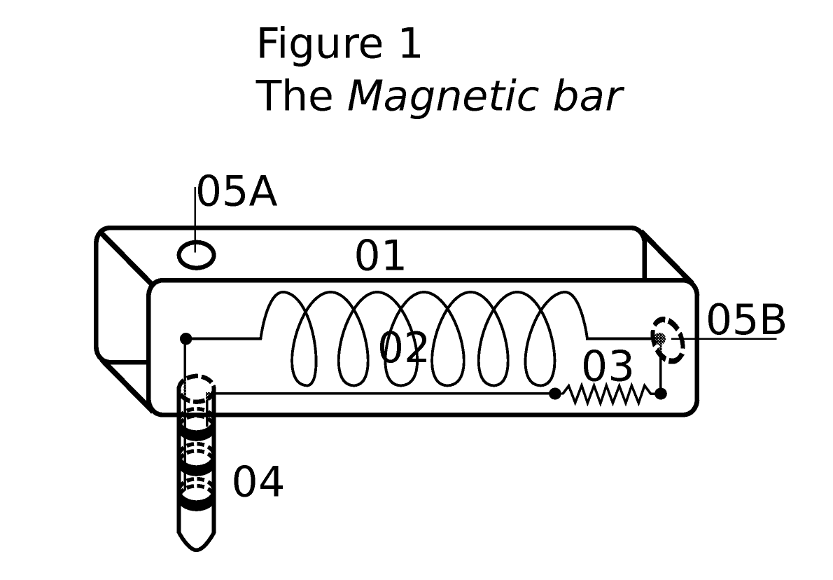

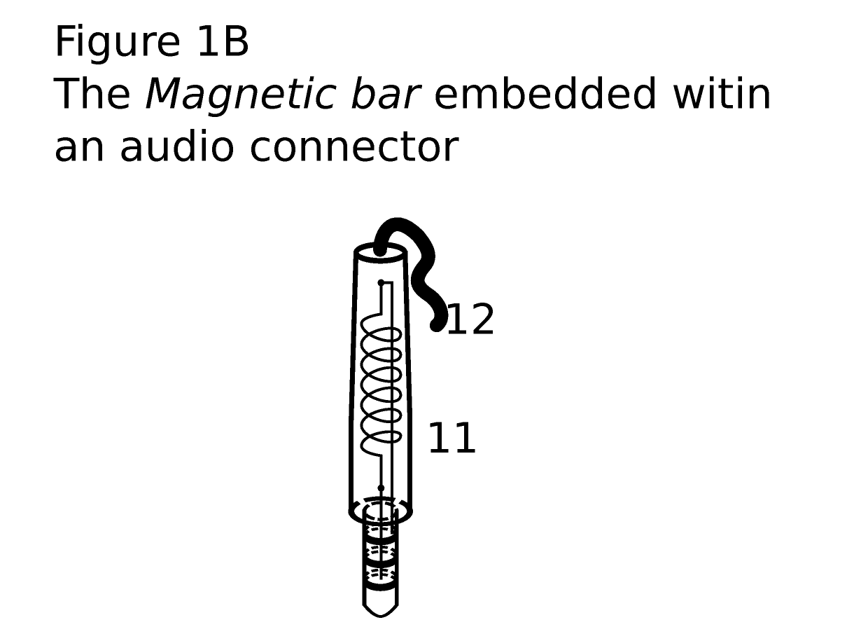

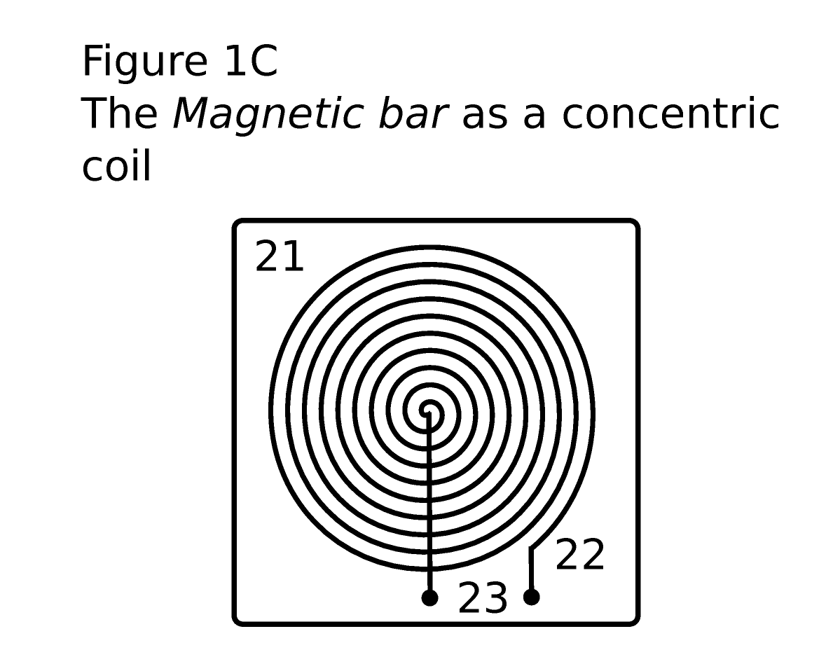

At the time I write this invention it is my opinion that the best realization of this invention would be using a smartphone. Since phones today do not have a dedicated electromagnetic inducer it is expected that an apparatus such as the one I named Magnetic bar (see FIG. 1) will be used. As the technology described in this invention gains popularity such required components can become an integral part of the smartphone. However, after much research and experimentation I do know that smartphones may be endowed with the utility of this invention by using other components that they already have. The impetus for this research is the fact that speakers and motors generate magnetic waves as an artifact of their core function. A few examples are the internal speaker, internal vibration component, and an external earpiece speaker. Moreover, to enable magnetic induction over larger distance, magnetic induction amplification may be realized by using an apparatus similar to the one shown in FIG. 1C and this apparatus, along with its required circuitry may be embedded in the smartphone case (or skin as it is often colloquially called), for example.

Referring to FIG. 1, the Magnetic bar 01 is a small bar, about (length×width×height) of (30 mm×5 mm×5 mm) in its large form-factor. Preferably made from plastic but any material that does not shield electromagnetic waves will do. The electronic circuit performing the electromagnetic waves generation is housed within the Magnetic bar. The user connects this apparatus 01 to their smartphone via the audio connector 04.

Software on the smartphone has access to the original magnetic card data and uses it to timely generate the peaks and valleys (signal) representing it.

The signal appears over the audio jack connector 04 and the inductor array 02 inducts the electromagnetic waves directly into the legacy magnetic card reader coil or one of its subsequent units by using mutual induction phenomenon. Component 02 represents an inductor array and not necessarily a single coil; it is a discrete (located in a single location) coil array. Since the read head is small discrete position would suffice and only the timing of generating the bits is important. The resistor 03 is used to affect the timing of the RL circuit and is optional.

Since the Magnetic bar occupies the smartphone's audio jack I recommend that the audio jack will be optionally made available as a jack on the bar. Either on its top as shown in FIG. 1 by port 05A, or the side 05B (preferably the right side because then the earpiece connector would not protrude beyond the smartphone dimensions). While I believe that the audio jack is optimal for generating the time-varying current in the RL circuit nothing prevents one skilled in the art to use other jacks (I/O ports) for driving the circuit.

Depending on the desired physical orientation of the apparatus connected to the smartphone, different coil arrays may be employed. For example a toroid will generate a magnetic field directed along its cylindrical region axis, and a saddle coil will generate a magnetic field parallel to the diameter of that the same cylindrical region. As one skilled in the art could see, the desired amount of magnetic flux, dictated by the desired proximity to the legacy read head and type, would determine if more than one coil 02 is needed in the coil array, as well as the coil(s) location(s), the number of winds, and whether a ferromagnetic core would be used. Similar considerations apply to other embodiments of this invention such as the most effective structure for this invention to be embedded in a smartphone cover, taking into account both the desired thinness of the case and a convenient distance from the smartphone to the legacy magnetic reader.

The auxiliary apparatus can be realized in many form factors. For example, it can be a dedicated apparatus with the sole purpose of generating magnetic card data, as 01 is. If the apparatus will make available an audio jack in place of the one it occupies, then the users can keep the apparatus continuously attached to their smartphones. As another example embodiment of this invention FIG. 1B shows the apparatus of this invention embedded within an audio connector 11. The regular cable going to the earpiece is depicted as 12.

Referring to FIG. 1C, yet another embodiment is a coil 22 that is not wrapped along a cylindrical axis, rather wrapped in a concentric manner. Such a coil can be made into a thin sticker 21 or similar form factor and be kept permanently attached to the back of the phone. Port 23 depicts the electric connection to the rest of the apparatus of this invention. Other physical arrangements of coils are useful and would still fit within a smartphone cover; specifically a regular coil (as shown in FIG. 1B for example) having a small radius could be used. To further enhance the magnetic properties of such a coil it may be wrapped around a ferromagnetic material.

In view of the foregoing description it is specifically noted that a chief objective of this invention disclosure is to enable a magnetic card inducer apparatus, comprised of a very simple external device to be used in conjunction with a smartphone and software, which is responsible for the signal generation in the appropriate timing. Moreover, the inducer apparatus can become an integral, internal, and standard component of the smartphone—to which end we have already proposed three such components, namely the speakers and vibration component.

A further objective of this invention disclosure, as one skilled in the art can see from the use of the simple RL circuit is construct a magnetic card inducer apparatus that is simple and cost effective to manufacture while still being of high reliability. The magnetic inducer apparatus can write one or more of the tracks, similar to the legacy cards. The inducer apparatus is designed to be small and easily carried in a pocket, wallet, or kept permanently attached to the smartphone. Of particular interest of this disclosure is a inducer device that is powered by the smartphone itself and does not require its own power source, but powered embodiments are also of interest because they can enable the utility of this patent over greater distances.

Some magnetic card readers require the presence of a physical card to activate their reading mechanism. For these cases I suggest that the auxiliary apparatus will be a thinner bar such that it can be inserted into the magnetic card reader lips. A slab with approximate dimensions (length×width×thickness) of (30 mm×10 mm×0.762 mm) will suffice. Note that this is smaller and different from the legacy cards, which has dimensions (85.725 mm×53.975×0.762 mm) and thus is novel in and of itself.

The apparatus can optionally act as a pickup head and in concert with the software running on the smartphone detect the distance between the apparatus described in this invention and the magnetic card reader. I recommend using the same electromagnetic phenomenon of induction to facilitate this detection. Once such a process is established, a determination by the software that the apparatus is within the desired distance (for example 2-5 cm) from the magnetic reader can start transmitting the data. This further reduces the risk of fraud as no data is inducted until only the apparatus and reader are near each other. I recommend that such proximity detection will be done by the method of this invention emitting a known magnetic wave, which will be picked by a reader and through induction reflected back at the apparatus of this invention.

The last embodiment I would like to discuss is by abstracting the smartphone components and using them beyond their prescribed use to perform electromagnetic induction. Example of such use was already discussed above. While not all smartphones may be capable of such an act, some do, and until a component that realizes this invention is made part of standard smartphone, it is worthwhile to enable such a function on smartphones that can. The idea is to find a component or combination of components that can be electrically excited in such a way that it inducts the desired sequence of signals in the legacy magnetic card reader. In the time since the submission of the provisional application I have demonstrated that such an act is possible by using the internal speaker of iPhones versions 4 and 5.

The smartphone, for example by using an App on the smartphone will be responsible for housing the available cards' proxies. As noted before the smartphone can hold all of the required card data or have access to it via the Internet. After the user selects the desired card to be used for a given transaction (financial or not) the user will hover the smartphone over the legacy magnetic card reader and the data will be inducted to the reader or one of its subsequent units. This enables users to use their smartphone as a magnetic card payment method and for other non-financial transactions (e.g. club access).

An addition benefit of this invention is that current-data, incentives, and coupons that are relevant to the undergoing transaction can be displayed or offered. While it is not a must-have condition for the usefulness of this invention, if the mobile device have Internet connectivity, then this invention make the following benefits available:

Be that a shared (or not) interest of the credit card company, the merchant, or any other third party—the available limit in each specific card can be displayed and participate in the selection process of the user. An indication to a benefit to use a specific card can be displayed in as the card selection process takes place. A coupon, bonus, or promotion that is relevant to the currently going transaction can be offered.

Another advantage of this invention over legacy cards is aid in case of theft. If a wallet full with legacy cards is lost or stolen the user need to recollect which of the cards are missing. After compiling a (possibly incomplete) list the owner need to call, access web sites, or in the worse case physically go to a number of organizations to cancel the cards and order new ones. The present invention stores all of the cards, with the option to store only pointers to the card data (and not the data itself) on a mobile device. Then, in case of a need, the user can cancel one ore more cards. The present invention enables an easy to access web interface that would allow the user to immediately and centrally stop the use any of the cards.

An additional option that the user can decide to use under this invention is to bind a unique identifier of the mobile device with a key-value pair denoting the original card. The unique identifier of the mobile device can be for example its MAC address or nonvolatile ID chip. The location in which the transaction is occurring can also be used to identify the transaction or add value-add services while the transaction is occurring. If that option is activated by the user, then the process will verify before enabling a transaction with a remote server that the card proxy on this mobile device is the singleton instance that is allowed to make transactions. By enabling this process an attempt to use a duplicate instance of the card's proxy will be stopped. In other words, while there can be two proxies of the same card on two mobile devices due to some fraudulent activity, the users can enable this process such that only one of the mobile devices will have the correct identifiers for the transaction to be approved.

Yet an additional security benefit of the data stored in the mobile device is that an object (such as a running sequence number) or other unique identification of the transaction (such as a checksum of the magnetic data and monetary value of the transaction, time, or location) can be computed by the mobile device and transferred to the magnetic card reader using the same mutual induction technique.

As an additional benefit we disclose a process in which the cardholder, in particular when the card is used as a payment method but one skilled in the art could see benefits to other cases as well, would get additional information before choosing which card they wish to use. As examples, and without limiting the type of information that can be provided under this process, I offer the following use-cases: In the first use-case, while the user is about to select which card they wish to use (using the mobile device interface), the currently available credit can be displayed. In the second example the merchant offers special benefits (such as a relevant coupon) to using some card(s) over others.

1. Transferring data from a smartphone directly to a magnetic card reader or one of its subsequent units by the principle of mutual induction.

2. The method of claim 1 in which the data is transferred by RF.

3. The method of claim 1 in which the handheld device is an artifact other than a smartphone, for example a key fob.

4. The method of claim 1 in which the data to be transmitted is generated by a data inducer apparatus (for example the Magnetic bar).

5. The method of claim 4 in which the apparatus is part of a smartphone case.

6. The method of claim 1 in which the data to be induced is generated by existing component(s) of the smartphone (for example its internal speaker, vibration component, or external earpiece speakers).

7. Magnetic data inducer apparatus (for example the Magnetic bar) for inducing data in a magnetic reader.

8. The method of claim 7 in which the device is connected to a smartphone via the audio, another jack, or wirelessly (for example Bluetooth).

9. The method of claim 7 where the inducer is an integral part (made into a standard component) of the smartphone.

10. The method of claim 7 where the inducer circuit is embedded in an earpiece (audio) connector.

11. The method of claim 7 where the inducer circuit is a thin and thus practical to be attached to one of the smartphone's sides (as in be part of the smartphone case or an attached sticker).

12. The method of claim 7 in which the coil is not electrically connected to the smartphone, but the data is transferred to it by induction or RF (e.g. Bluetooth) from the smartphone.

13. The method of claim 7 where the inducer physical shape is such of slab, similar in thickness to a legacy card.

14. The method of claim 7 in which the inducer is used as a pickup head to sense its distance from the magnetic card reader, to be used as a measure of distance in order to decide when to transfer the data.

15. Software running on a smartphone to facilitate the generation of appropriately timed signals, where the signals induce the content of a magnetic stripe into a magnetic card reader or one of its subsequent units.

16. The method of claim 15 in which a one-to-one uniquely identifying key-value pair is related to each card and is coupled with a unique identifier of the mobile device (such as the MAC address or ID chip). The key is stored in a remote server. The software verifying if the card instance on this mobile device is an allowed proxy of the card.
